(19) United States
(12) Patent Application Publication
(10) Pub. No.: US 2018/0310660 A1
(43) Pub. Date: Nov. 1, 2018

(54) Shoe Protection Device

(71) Applicant: Donna Hines, Northborough, MA (US)

(72) Inventor: Donna Hines, Northborough, MA (US)

(21) Appl. No.: 15/497,284

(22) Filed: Apr. 26, 2017

(51) Int. Cl. A43B 5/00; B60N 3/04

(52) U.S. Cl. CPC A43B 5/007; B60N 3/044

(57) ABSTRACT

The disclosure as detailed herein is in the technical field of Footwear accessories. The invention is a cushion that can be reversibly attached to a car's components. The advantage is that it is removable and easy to clean and provides a cushioned barrier to protect a person's heel/shoe and a car's components. The Shoe Protector Device allows a person to protect the heel of the person's shoe by forming a protective layer between the heel and floor board and/or floor mat. It also allows for protection from damage to the floor mats and/or floor board. It prevents uneven wear on shoes that may be expensive to fix. Because the Shoe Protector Device is removable, it is easy to clean in case of dirt or moisture accumulation. It provides cushioning for a person's heel to prevent pain or discomfort when driving long distances.

### CROSS REFERENCE TO RELATED APPLICATIONS

Not applicable

### REFERENCE TO GOVERNMENT FUNDING SOURCES

Not applicable

### REFERENCE TO SEQUENCE LISTING

Not applicable

### FIELDS OF THE INVENTION

The disclosure as detailed herein is in the technical field of Footwear accessories. More specifically, the present disclosure relates to the technical field of Vehicle accessories. Even more specifically, the present disclosure relates to the technical field of Protection for footwear.

### DESCRIPTION OF RELATED ART

Lack of cushioning between a person's heel and a car's components, such as the floor board, floor mats, and pedals, can cause heel pain/discomfort and damage to both the person's shoes and the car's components. The invention is a cushion that can be reversibly attached to a car's components. The advantage is that it is removable and easy to clean and provides a cushioned barrier to protect a person's heel/shoe and a car's components.

### GENERAL SUMMARY OF THE INVENTION

When a person drives, the gas pedal is near the floor of the car and operated by the person's right foot. The person rocks their foot on its heel as a means of applying pressure to the gas pedal. This constant motion causes scuff marks on a person's shoe. This constant motion can also cause wear and tear on the car's floor mats and/or floor board. Excessive wear and tear on the right shoe causes uneven wear between shoes. Moisture and/or dirt on the car floor board and/or floor mat can cause stains on the person's shoe. When driving long distances, the constant pressure on a person's heel can cause pain or discomfort because of the lack of cushioning.

The Shoe Protector Device allows a person to protect the heel of the person's shoe by forming a protective layer between the heel and floor board and/or floor mat. It also allows for protection from damage to the floor mats and/or floor board. It prevents uneven wear on shoes that may be expensive to fix. Because the Shoe Protector Device is removable, it is easy to clean in case of dirt or moisture accumulation. It provides cushioning for a person's heel to prevent pain or discomfort when driving long distances.

### DESCRIPTION OF FIGURES

FIG. 1 is a perspective view, which shows the main view of the shoe protector device.

FIG. 2 is a perspective view, which shows an up-close view of the shoe protector device on the floor.

FIG. 3 is a perspective view, which shows a side view of the shoe protector device.

FIG. 4 is a perspective view, which shows a top down view of the shoe protector device.

FIG. 5 is a perspective view, which shows a cross section of the shoe protector device.

FIG. 6 is a perspective view, which shows a cross section of the shoe protector device with cushion filling.

FIG. 7 is a perspective view, which shows an exploded view of the shoe protector device.

FIG. 8 is a perspective view, which shows an exploded view from below of the shoe protector device.

FIG. 9 is a perspective view, which shows an exploded side view of the shoe protector device.

FIG. 10 is a perspective view, which shows a top view of the adherence component and cushion component of the shoe protector device together.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure.

In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions.

Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions.

It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions.

Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step).

Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise.

Process descriptions or blocks in figures should be understood as representing modules, segments, or portions of code which include one or more executable instructions for implementing specific logical functions or steps in the process.

Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

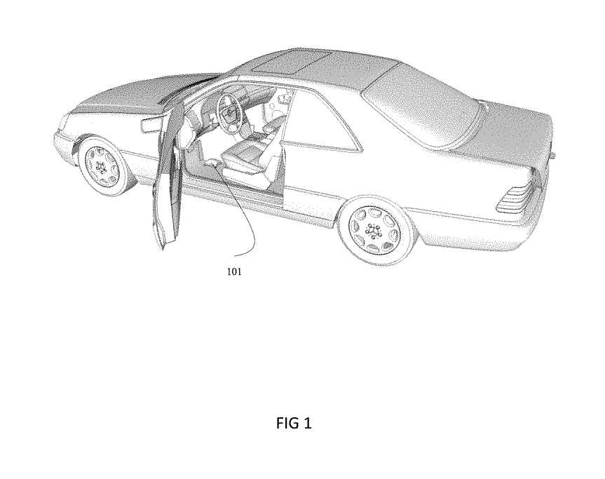

Referring now to FIG. 1, which shows the main view of the shoe protector device. The shoe protector device 101 comprises a modular removable apparatus for protecting footwear and the car components 204.

The shoe protector device 101 interacts with multiple objects and/or surfaces: it interacts with the car components 204 and it also interacts with footwear.

The shoe protector device 101 has many purposes which are as follows: First, the purpose of the shoe protector device 101 is to protect the heel of the footwear. Next, it serves to prevent wear and tear on the car components 204. Next, it serves to prevent damage to the car floor and/or floor board. Lastly, the shoe protector device 101 serves to prevent damage to the carpeting.

The shoe protector device 101 has an alternative embodiment herein termed a “two pedal” embodiment and another termed a “two pedal with stitch” embodiment. The “two pedal” embodiment comprises an embodiment wherein a person may have a larger sized device that allows the use of the device for two adjacent pedals (for example, a clutch and accelerator).

The “two pedal with stitch” embodiment comprises an embodiment wherein a person may have a larger sized device that allows the use of the device for two adjacent pedals (for example, a clutch and accelerator), separated by stitching that forms the nominal shape of an individual shoe protector device 201.

The shoe protector device 101 comprises an adherence component 201 and a cushion component 202.

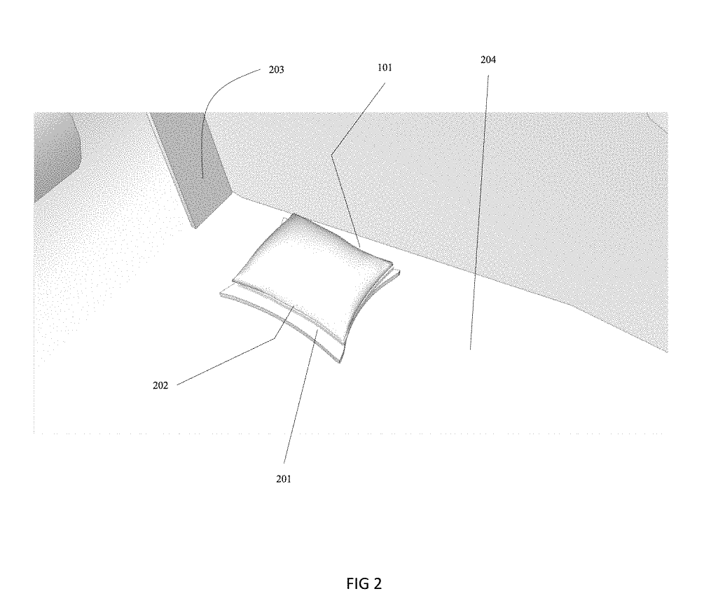

Referring now to FIG. 2, which shows an up-close view of the shoe protector device on the floor. The adherence component 201 comprises a mechanism that binds to the outer shell bottom portion 302 and also binds to the car components 204 such that it is stable when in use and can also be removed when not in use.

The adherence component 201 is attached to the car components 204 and a cushion component 202. Spatially, the adherence component 201 is preferably positioned below the outer shell bottom portion 302.

The adherence component 201 is preferably shaped like a rectangle; however, it is thought that in alternative embodiments that it may also be shaped like a triangle, a circle, or a rectangle.

The adherence component 201 is mainly thought to be composed of structural teeth; however other embodiments may be composed of any of the following: tacks, snaps, or structural combs.

In some embodiments, the adherence component 201 has a preferred width of 15.24 centimeters but in some embodiments, may range from a minimum of 10.16 centimeters to a maximum width of 30.48 centimeters.

In some embodiments, the adherence component 201 has a preferred length of 15.24 centimeters but in some embodiments, may range from a minimum of 10.16 centimeters to a maximum length of 30.48 centimeters.

In some embodiments, the adherence component 201 has a preferred area of 232.258 centimeters square but in some embodiments, may range from a minimum of 103.226 centimeters square to a maximum area of 464.515 centimeters square.

The adherence component 201 comprises an adherence component base portion 801 and an adherence component outer shell portion 902. The cushion component 202 comprises a component wherein the footwear rests during use and provides a soft cushion for the footwear.

The cushion component 202 interacts with multiple objects and/or surfaces: it interacts with the footwear and it also interacts with the adherence component 201.

The cushion component 202 is attached to an adherence component 201. The cushion component 202 is preferably positioned above the car components 204, below the footwear, and on top of the adherence component 201.

The cushion component 202 is preferably shaped like a rectangle, however, it is thought that in alternative embodiments that it may also be shaped like a square, a triangle, or a circle.

The cushion component 202 comprises an outer shell 303 and an inner shell 501.

In some embodiments, it is thought that examples of a pedal 203 may include: a parking brake, an accelerator/throttle, a brake, or a clutch.

The pedal 203 comprises a component acted upon by the foot in a vehicle in order to operate said vehicle.

In some embodiments, it is thought that examples of car components with which the foot/heel interacts with 204 may include: a metal floor, carpet, upholstery, mats, a vehicle floor, or a floor board. The car components 204 comprises the substrates of a vehicle that allows the adherence component base portion 801 to attach to it.

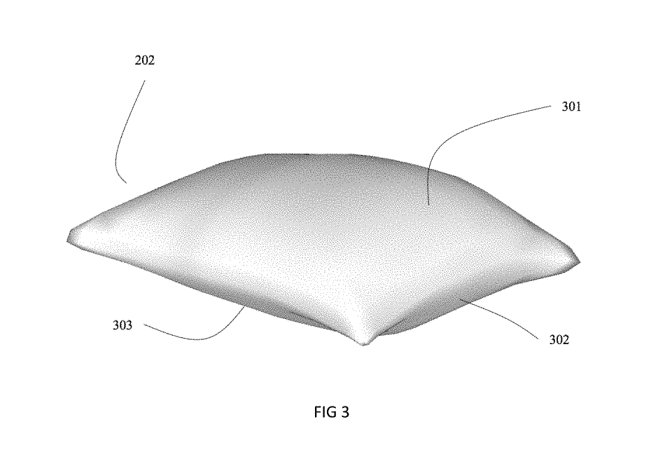

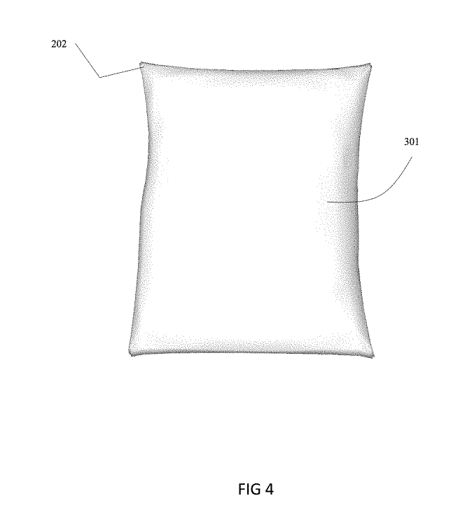

Referring now to FIG. 3, which shows a side view of the shoe protector device and referring to FIG. 4, which shows a top down view of the shoe protector device. The outer shell top portion 301 comprises a portion of the outer shell 303 that is primarily for receiving one or more components of the footwear, in order to prevent foot wear damage.

The outer shell top portion 301 interacts with footwear when a person rests their footwear for extensive periods of time on the shoe protector device 101.

The outer shell bottom portion 302 comprises a portion of the outer shell 303 and is primarily for mediating or affixing an adherence component 201 for stability when in use. The outer shell bottom portion 302 is attached to an adherence component outer shell top portion 701. Spatially, the outer shell bottom portion 302 is preferably positioned above the adherence component outer shell top portion 701.

One goal of the outer shell bottom portion 302 is to allow the affixation or interaction with the adherence component outer shell top portion 701.

The outer shell bottom portion 302 has an alternative embodiment herein termed “doubles as the adherence component outer shell portion”. The “doubles as the adherence component outer shell portion” comprises an embodiment where the outer shell bottom portion 302 is also the adherence component 201.

The outer shell 303 comprises a protective bladder to encase the cushion filling 601 in order to prevent damage and maintain malleability to the device.

The outer shell 303 interacts with multiple items: First, the outer shell 303 interacts with an inner shell 501. Next, it interacts with the footwear. Finally, it interacts with the adherence component 201.

Spatially, the outer shell 303 is preferably positioned surrounding the inner shell 501. The outer shell 303 is preferably shaped like a rectangle; however, it is thought that in alternative embodiments that it may also be shaped like a square, circle, or triangle.

The outer shell 303 is mainly thought to be composed of water resistant, flexible material; however other embodiments may be composed of any of the following: rubber, polyethylene, comfortable waterproof fabric, leather, or plastic.

In some embodiments, the outer shell 303 has a preferred thickness of 2 millimeters but in some embodiments, may range from a minimum of 0.1 millimeters to a maximum thickness of 20 millimeters.

In some embodiments, the outer shell 303 has a preferred volume of 500 cubed centimeters but in some embodiments, may range from a minimum of 250 cubed centimeters to a maximum volume of 1125 cubed centimeters.

In some embodiments, the outer shell 303 has a preferred width of 15.24 centimeters but in some embodiments, may range from a minimum of 10.16 centimeters to a maximum width of 30.48 centimeters.

In some embodiments, the outer shell 303 has a preferred length of 15.24 centimeters but in some embodiments, may range from a minimum of 10.16 centimeters to a maximum length of 30.48 centimeters.

In some embodiments, the outer shell 303 has a preferred area of 232.258 centimeters square but in some embodiments, may range from a minimum of 103.226 centimeters square to a maximum area of 464.515 centimeters square.

The outer shell 303 has multiple purposes some of which are as follows: First, the purpose of the outer shell 303 is to give integrity to the inner shell 501 so that its shape is not altered by the pressure when still in use. Next, it serves to add an extra layer of protection to keep the inner shell 501 from leaking out. Lastly, the outer shell 303 serves to assist the outer shell 303 maintain its original shape.

The outer shell 303 comprises an outer shell top portion 301 and an outer shell bottom portion 302.

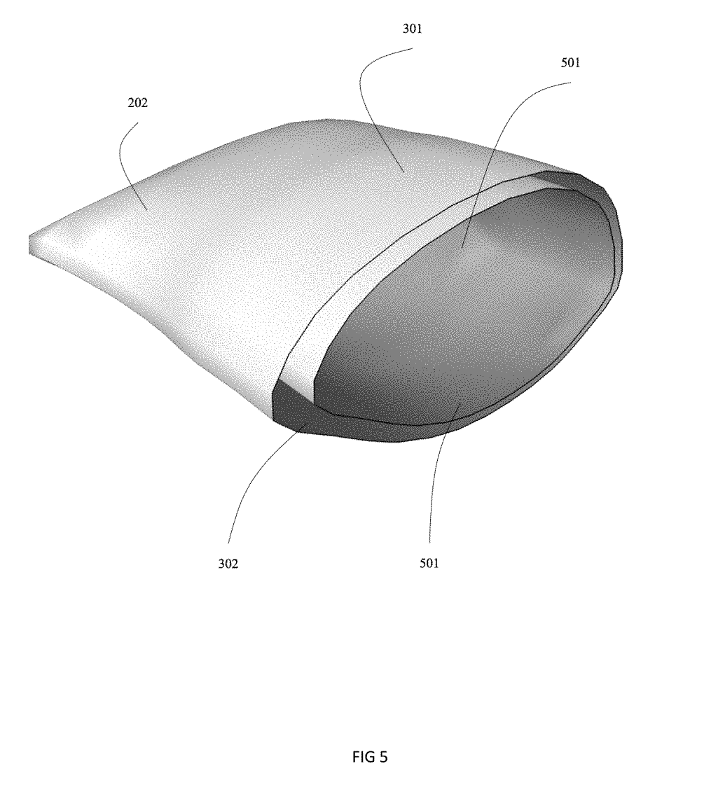

Referring now to FIG. 5, which shows a cross section of the shoe protector device. The inner shell 501 comprises a protective bladder to encase the cushion filling 601 in order to prevent damage and maintain malleability.

The inner shell 501 interacts with an outer shell 303. Spatially, the inner shell 501 is preferably positioned within the outer shell 303 and surrounding the cushion filling 601.

The inner shell 501 is mainly thought to be composed of water resistant, flexible material; however other embodiments may be composed of any of the following: rubber, polyethylene, or plastic.

In some embodiments, the inner shell 501 has a preferred volume of 500 centimeters cubed but in some embodiments, may range from a minimum of 250 centimeters cubed to a maximum volume of 1125 centimeters cubed.

In some embodiments, the inner shell 501 has a preferred thickness of 2 millimeters but in some embodiments, may range from a minimum of 0.1 millimeters to a maximum thickness of 20 millimeters.

In some embodiments, it is thought that if the inner shell 501 is absent, then the shoe protector device 101 may still work; however, it is more likely to be susceptible to damage to the footwear, car components and the device itself.

The inner shell 501 has many purposes which are as follows: First, the purpose of the inner shell 501 is to give integrity to the cushion filling 601 so that its shape maintains its integrity and is not substantially altered. Next, it serves to add an extra layer of protection to keep the cushion filling 601 from leaking out. Lastly, the inner shell 501 serves to help the outer shell 303 maintain its original shape in order to protect the footwear, car components and device itself.

The inner shell 501 preferably comprises a cushion filling 601.

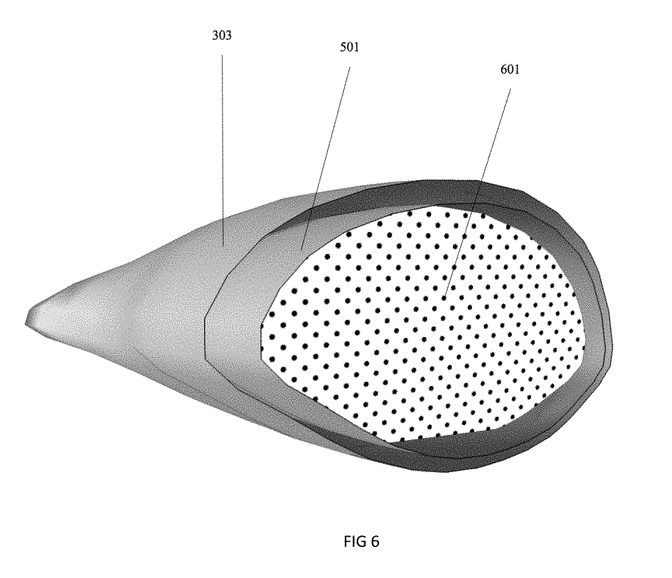

Referring now to FIG. 6, which shows a cross section of the shoe protector device with cushion filling. The cushion filling 601 comprises a filling that allows one to substantially support the weight of a person's foot so that the inner shell 501 does not collapse to make the inner shell 501 top and bottom portions not interact with each other.

Spatially, the cushion filling 601 is preferably positioned within the inner shell 501. The cushion filling 601 is preferably shaped like a rectangle, however, it is thought that in alternative embodiments that it may also be shaped like a square, a triangle, or a circle.

The cushion filling 601 is mainly thought to be composed of sand; however, it is thought that in alternate embodiments that the cushion filling 601 may also be composed of beading, synthetic beading, foam, gelatinous liquids.

In some embodiments, the cushion filling 601 has a preferred volume of 500 centimeter cubed but in some embodiments, may range from a minimum of 250 centimeter cubed to a maximum volume of 1125 centimeter cubed.

One goal of the cushion filling 601 is to allow the reformable deformation of the outer shell 303 and inner shell 501 when footwear is placed on the shoe protector device 101.

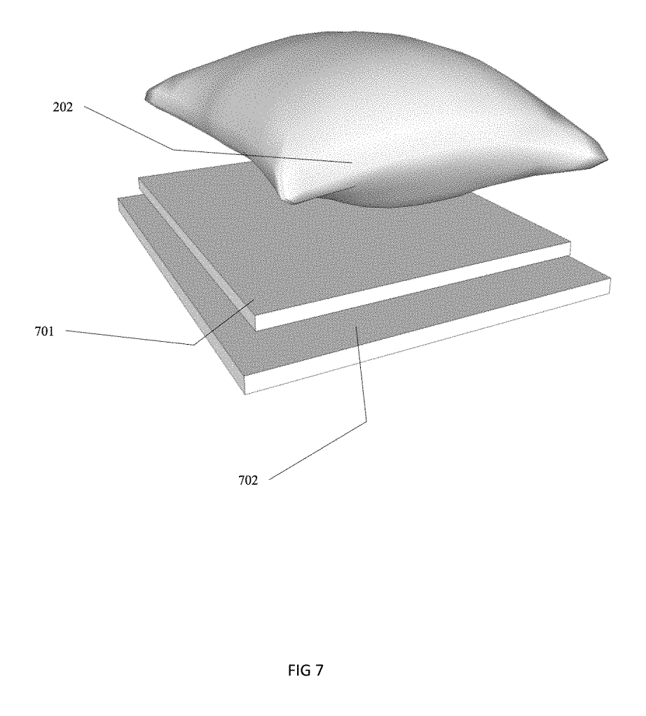

Referring now to FIG. 7, which shows an exploded view of the shoe protector device. The adherence component outer shell top portion 701 comprises a means to attach to the outer shell bottom portion 302. The adherence component outer shell top portion 701 is attached to an outer shell bottom portion 302.

Spatially, the adherence component outer shell top portion 701 is preferably positioned below the outer shell top portion 301 and opposite the adherence component outer shell bottom portion 901.

The adherence component outer shell top portion 701 is mainly thought to be composed of structural teeth; however, in some embodiments, it is thought that the adherence component outer shell top portion 701 may also be composed of tape, glue, tacks, snaps or other such appendages of adherence.

The adherence component outer shell top portion 701 has an alternative embodiment herein termed a “permanently attached” embodiment and another termed a “reversibly attached” embodiment. The “permanently attached” embodiment comprises an embodiment where the adherence component outer shell top portion 701 is permanently attached to the cushion component.

The “reversibly attached” embodiment comprises an embodiment wherein the adherence component outer shell top portion 701 can be removably attached to the cushion component.

The adherence component base top portion 702 comprises a means to reversibly affix to the adherence component outer shell bottom portion 901. The adherence component base top portion 702 is attached to the adherence component outer shell bottom portion 901. Spatially, the adherence component base top portion 702 is preferably positioned below the adherence component outer shell bottom portion 901 and opposite the adherence component base bottom portion 802.

The adherence component base top portion 702 is mainly thought to be composed of structural teeth; however, it is thought that in alternate embodiments, that the adherence component base top portion 702 may also be composed of tape, glue, tacks, snaps or other such appendages of adherence.

One goal of the adherence component base top portion 702 is to allow the removable interaction of the adherence component base portion 801 from the adherence component outer shell portion 902.

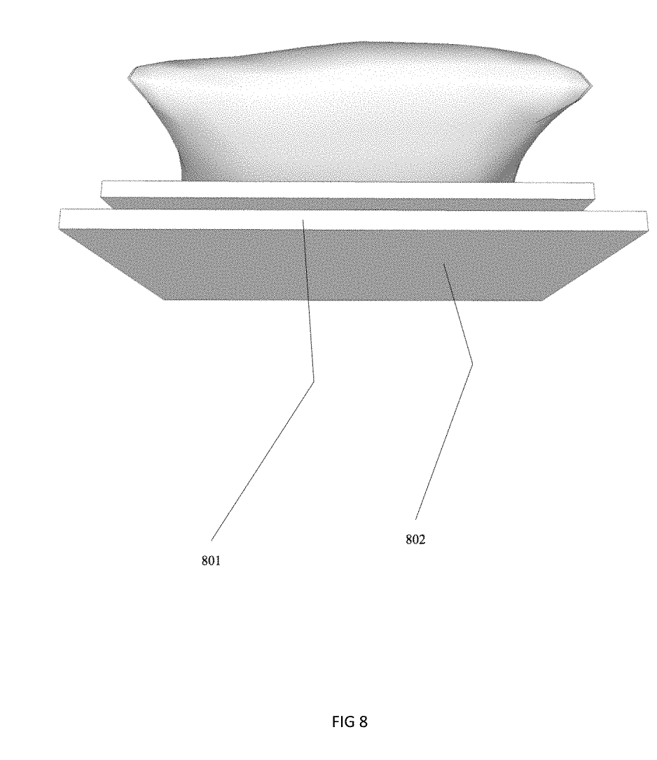

Referring now to FIG. 8, which shows an exploded view from below of the shoe protector device. The adherence component base portion 801 comprises a portion of the adherence component 201 that in some embodiments, may be affixed to a particular position on the car components 204 wherein the user has determined that this is the optimal position for its use.

The adherence component base portion 801 is attached to an adherence component outer shell portion 902 and the vehicle floor substrate. Spatially, the adherence component base portion 801 is preferably positioned below the outer shell bottom portion 302.

The adherence component base portion 801 is mainly thought to be composed of structural teeth; however, it is thought that in alternate embodiments that the thing may also be composed of tacks, snaps, or structural combs.

In some embodiments, it is thought that if the adherence component base portion 801 is absent, then the adherence component outer shell portion 902 may directly interact and bind with the car components 204.

The adherence component base portion 801 comprises an adherence component base top portion 702 and an adherence component base bottom portion 802. The adherence component base bottom portion 802 comprises a means to affix to the car components 204.

The adherence component base bottom portion 802 is attached to the car components 204. Spatially, the adherence component base bottom portion 802 is preferably positioned on top of the car components 204 and opposite the adherence component base top portion 702. The adherence component base bottom portion 802 is mainly thought to be composed of structural teeth; however, other embodiments may be composed of any of the following: structural teeth, tack, or structural combs.

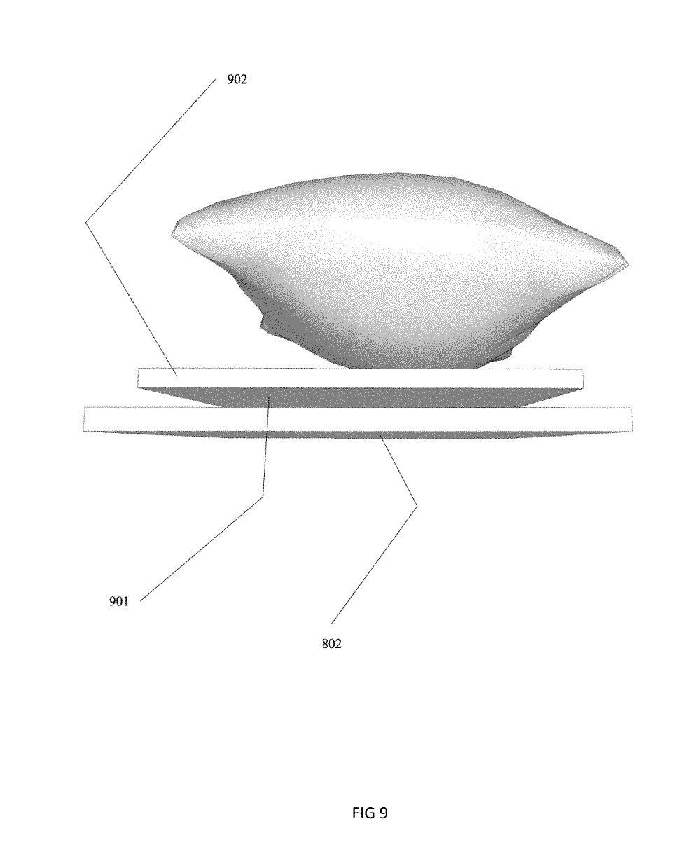

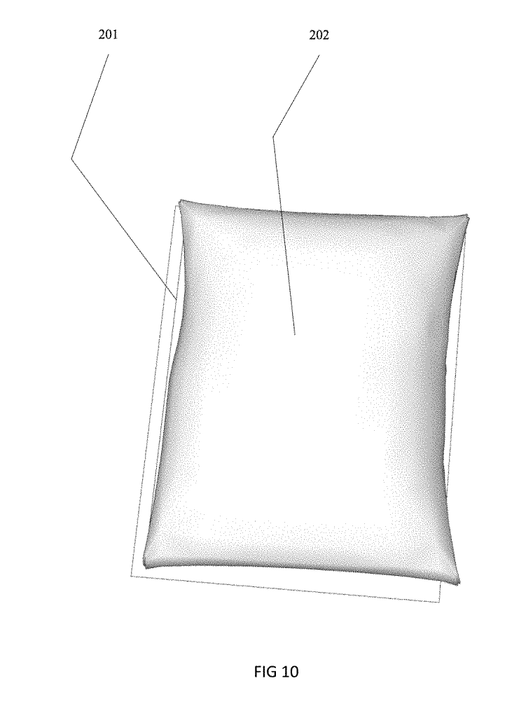

Referring now to FIG. 9, which shows an exploded side view of the shoe protector device and referring to FIG. 10, which shows a top view of the adherence component and cushion component of the shoe protector device together. The adherence component outer shell bottom portion 901 comprises a means to reversibly affix to the adherence component base top portion 702.

The adherence component outer shell bottom portion 901 is attached to an adherence component base top portion 702. Spatially, the adherence component outer shell bottom portion 901 is preferably positioned opposite the adherence component outer shell top portion 701.

The adherence component outer shell bottom portion 901 is mainly thought to be composed of structural teeth; however, it is thought that in alternate embodiments that it may also be composed of snaps.

The adherence component outer shell portion 902 comprises a portion of the adherence component 201 that is otherwise affixed to the outer shell bottom portion 302 and is the interaction means on the cushion component 202 that allows it to be separable from the adherence component 201.

The adherence component outer shell portion 902 is attached to an outer shell bottom portion 302 and an adherence component base top portion 702. The adherence component outer shell portion 902 is preferably positioned on the bottom of the cushion component 202, below the outer shell bottom portion 302, and above the adherence component base top portion 702.

The adherence component outer shell portion 902 comprises an adherence component outer shell top portion 701 and an adherence component outer shell bottom portion 901.

Referring now to FIG. 11, which shows the overall use of shoe protector device. In a first step, they place the shoe protector device 101 near the ventral portion of the pedal 203 or in some embodiments, when operating the vehicle wherever the heel and/or portion of the shoe of the footwear contacts the vehicle floor (Step 1101).

If the person has more than one pedal 203 (Step 1102), then they may place another shoe protector device 101 near the ventral portion of the clutch or another pedal 203 (Step 1103). From Step 1101, if the person has only one pedal 203 (Step 1115), then refer to Step 1104.

Next, they locate an area of the car components 204 in order to apply the adherence component base portion 801 such that the adherence component base bottom portion 802 is removably attached to the floor (Step 1104).

Next, they position the shoe protector device 101 such that the cushion component 202 outer shell top portion 301 is facing away from the floor and the outer shell bottom portion 302 is toward the floor (Step 1105). From Step 1105, if they can put the shoe protector device 101 on the side of car components (Step 1113), then they position the shoe protector device 101 such that the cushion component 202 outer shell top portion 301 is facing the open, unattached side and the cushion component 202 outer shell bottom portion 302 is facing the side to which the cushion component 202 is attached (Step 1114). Then, refer to Step 1106.

Next, they place the cushion component 202 above the adherence component base top portion 702 and put in the desired position (Step 1106). Next, they adhere the adherence component outer shell bottom portion 901 to the adherence component base top portion 702 (Step 1107).

Next, a person places their foot on the outer shell top portion 301 and uses the device (Step 1108). If the person would like to reposition the adherence component base portion 801 (Step 1109), then they may remove the adherence component 201 by detaching it from the adherence component base bottom portion 802 (Step 1110). Then, refer to Step 1104.

From Step 1108, if the person would like to reposition the outer shell 303 (Step 1111), then they may remove the outer shell 303 from the adherence component base portion 801 and reposition it (Step 1112). Then, refer to Step 1106.

What is claimed is:

1. A shoe protector device comprising:
a. an adherence component wherein the adherence component further comprises:
i. an adherence component base portion wherein the adherence component base portion further comprises:
1. an adherence component base top portion, and
2. an adherence component base bottom portion, and
ii. an adherence component outer shell portion wherein the adherence component outer shell portion further comprises:
1. an adherence component outer shell top portion, and
2. an adherence component outer shell bottom portion, and
b. a cushion component, wherein the cushion component further comprises:
i. an inner shell which is further comprised of a cushion filling, and
ii. an outer shell which is further comprised of:
1. an outer shell top portion, and
2. an outer shell bottom portion.

2. The apparatus of claim 1 wherein the outer shell has a thickness ranging from 0.1 millimeters to a maximum of 20 mm, a width ranging from 10.16 to 30.48 centimeters, a length ranging from 10.16 to 20.48 centimeters, a volume ranging from 250 to 1125 cubed centimeters, an area ranging from 103.226 to 464.515 squared centimeters.

3. The apparatus of claim 1 wherein the inner shell has a volume ranging from a minimum of 250 centimeters cubed to a maximum volume of 1125 centimeters cubed a thickness ranging from a minimum of 0.1 millimeters to a maximum thickness of 20 millimeters.

4. The apparatus of claim 3 wherein the cushion filling volume ranges from a minimum of 250 centimeters cubed to a maximum volume of 1125 centimeters cubed.

5. The apparatus of claim 1 wherein the adherence component has a width ranging from 10.16 centimeters to a maximum width of 30.48 centimeters, and a length ranging from 10.16 centimeters to a maximum length of 30.48 centimeters, and an area ranging from 103.226 centimeters square to a maximum area of 464.515 centimeters square.

6. A shoe protector device comprising:
a. an adherence component where the adherence component has a width ranging from 10.16 centimeters to a maximum width of 30.48 centimeters, and a length ranging from 10.16 centimeters to a maximum length of 30.48 centimeters, and an area ranging from 103.226 centimeters square to a maximum area of 464.515 centimeters square wherein the adherence component further comprises:
i. an adherence component base portion wherein the adherence component base portion further comprises:
1. an adherence component base top portion, and
2. an adherence component base bottom portion, and
ii. an adherence component outer shell portion wherein the adherence component outer shell portion further comprises:
1. an adherence component outer shell top portion, and
2. an adherence component outer shell bottom portion, and
b. a cushion component, wherein the cushion component further comprises:
i. an inner shell where the inner shell has a volume ranging from a minimum of 250 centimeters cubed to a maximum volume of 1125 centimeters cubed a thickness ranging from a minimum of 0.1 millimeters to a maximum thickness of 20 millimeters and which is further comprised of a cushion filling where the cushion filling volume ranges from a minimum of 250 centimeters cubed to a maximum volume of 1125 centimeters cubed, and
ii. an outer shell where the outer shell has a thickness ranging from 0.1 millimeters to a maximum of 20 mm, a width ranging from 10.16 to 30.48 centimeters, a length ranging from 10.16 to 20.48 centimeters, a volume ranging from 250 to 1125 cubed centimeters, an area ranging from 103.226 to 464.515 squared centimeters which is further comprised of:
1. an outer shell top portion, and
2. an outer shell bottom portion.

7. A shoe protector device comprising:
a. an adherence component which has a width of 15.24 centimeters, a length of 15.24 centimeters, a preferred area of 232.258 centimeters square and where the adherence component further comprises:
i. an adherence component base portion wherein the adherence component base portion further comprises:
1. an adherence component base top portion, and
2. an adherence component base bottom portion, and
ii. an adherence component outer shell portion wherein the adherence component outer shell portion further comprises:
1. an adherence component outer shell top portion, and
2. an adherence component outer shell bottom portion, and
b. a cushion component, wherein the cushion component further comprises:
i. an inner shell which is further comprised of a cushion filling which has a volume of 500 centimeters cubed, and
ii. an outer shell which has a thickness of 2 millimeters, a volume of 500 cubed centimeters, a width of 15.24, a length of 15.24 centimeters, an area of 232.258 centimeters square which is further comprised of:
1. an outer shell top portion, and
2. an outer shell bottom portion.

8. A shoe protector device comprising:
a. an adherence component wherein the adherence component further comprises:
i. an adherence component base portion, and
ii. an adherence component outer shell portion, and
b. a cushion component, wherein the cushion component further comprises:
i. an inner shell, and
ii. an outer shell.

9. The apparatus of claim 8 wherein the outer shell has a thickness ranging from 0.1 millimeters to a maximum of 20 mm, a width ranging from 10.16 to 30.48 centimeters, a length ranging from 10.16 to 20.48 centimeters, a volume ranging from 250 to 1125 cubed centimeters, an area ranging from 103.226 to 464.515 squared centimeters.

10. The apparatus of claim 8 wherein the inner shell has a volume ranging from a minimum of 250 centimeters cubed to a maximum volume of 1125 centimeters cubed a thickness ranging from a minimum of 0.1 millimeters to a maximum thickness of 20 millimeters.

11. The apparatus of claim 10 wherein the inner shell is further comprised of a cushion filling wherein the cushion filling volume ranges from a minimum of 250 centimeters cubed to a maximum volume of 1125 centimeters cubed.

12. The apparatus of claim 8 wherein the adherence component has a width ranging from 10.16 centimeters to a maximum width of 30.48 centimeters, and a length ranging from 10.16 centimeters to a maximum length of 30.48 centimeters, and an area ranging from 103.226 centimeters square to a maximum area of 464.515 centimeters square.
